(19) United States
(12) Patent Application Publication
(10) Pub. No.: US 2019/0001378 A1
(43) Pub. Date: Jan. 3, 2019

(54) MOBILE CLEAN-IN-PLACE UNIT FOR WAREWASH MACHINES AND RELATED METHODS

(71) Applicant: ILLINOIS TOOL WORKS INC., Glenview, IL (US)

(72) Inventors: Alexander R. Anim-Mensah, Miamisburg, OH (US); Terry L. Presser, Houston, OH (US); Mary E. Paulus, Sidney, OH (US)

(21) Appl. No.: 16/013,111

(22) Filed: Jun. 20, 2018

Related U.S. Application Data
(60) Provisional application No. 62/525,808, filed on Jun. 28, 2017.

(51) Int. Cl. B08B 3/08; B08B 3/10; A47L 15/00

(52) U.S. Cl. CPC B08B 3/08; A47L 15/0076; B08B 3/10

(57) ABSTRACT

A mobile unit for cleaning warewashers at a facility includes a base structure with wheels to facilitate movement. A cleaning system is mounted on the base structure and includes a tank, an external recirculation delivery line running from the tank and including a pump therealong and an external recirculation return line running back to the tank. The delivery line and the return line are connectable to a warewash machine for recirculating liquid from the tank through the warewash machine and back to the tank for cleaning of the warewash machine. The machine of the previous aspect may include an on-board controller that automatically carries out cleaning operations, or the machine may be a manual machine that is operator controlled.

### TECHNICAL FIELD

This application relates generally to warewashers such as those used in commercial applications such as cafeterias and restaurants and, more particularly, to a mobile clean-in-place unit for such warewashers.

### BACKGROUND

Commercial kitchens often utilize multiple warewash machines that require regular cleaning, including occasional deliming in which the water flow paths along the rinse line, including the hot water booster, energy recovery unit, plate heat exchanger unit and/or the rinse piping needs, to be cleaned of scales or lime. Some machines include an integrated and automated delime system. However, some machines do not.

It would be desirable to provide a maintenance system to improve on the longevity and overall performance of warewash machines that do not include an integrated and automated delime system.

### SUMMARY

In one aspect, a mobile unit for cleaning warewashers at a facility includes a base structure with wheels to facilitate movement. A cleaning system is mounted on the base structure and includes a tank, an external recirculation delivery line running from the tank and including a pump therealong and an external recirculation return line running back to the tank. The delivery line and the return line are connectable to a warewash machine for recirculating liquid from the tank through the warewash machine and back to the tank for cleaning of the warewash machine.

The machine of the previous aspect may include an on-board controller that automatically carries out cleaning operations, or the machine may be a manual machine that is operator controlled.

In another aspect, a method of cleaning a warewasher in a facility involves: (a) utilizing a mobile unit having an on-board cleaning system that includes a tank, an external recirculation delivery line running from the tank, an external recirculation return line running back to the tank, and an internal recirculation line from the tank and back to the tank; (b) moving the mobile unit to a location of the warewasher; (c) connecting the external recirculation delivery line to a liquid input of the warewasher and connecting the external recirculation return line to a liquid output of the warewasher; (d) adding water and delimer to the tank; (e) operating the mobile unit to move the water and delimer along the internal recirculation line in order to mix the water and delimer into a cleaning solution; and (f) operating the mobile unit to move the cleaning solution along the delivery line, through the warewasher and back along the return line for cleaning of the warewasher.

The details of one or more embodiments are set forth in the accompanying drawings and the description below. Other features, objects, and advantages will be apparent from the description and drawings, and from the claims.

### DESCRIPTION

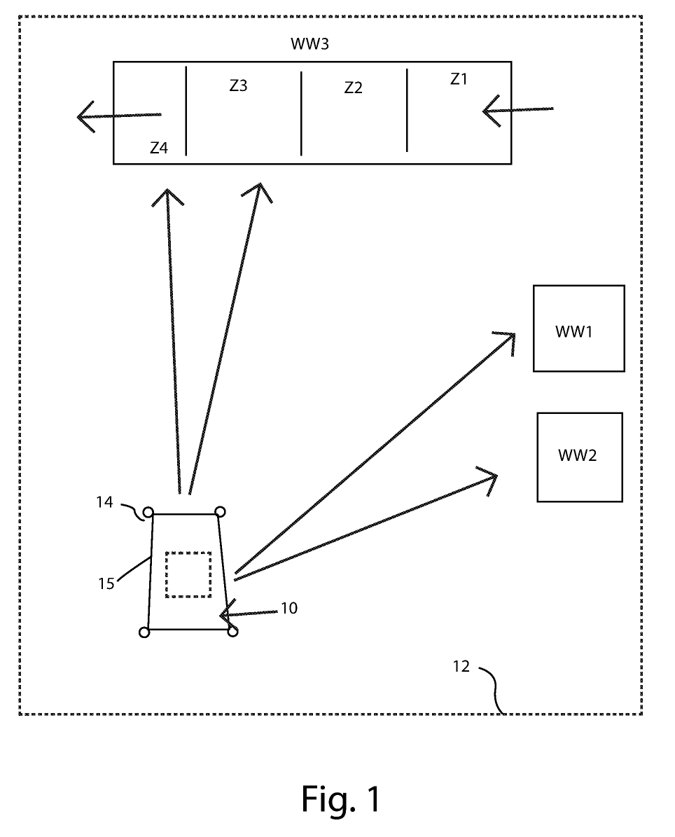

Referring to FIG. 1, a mobile clean-in-place unit 10 is shown that can be moved throughout a kitchen environment 12 for the purpose of cleaning multiple warewash machines in the kitchen environment, such as batch-type machines WW1 and WW2 and a higher volume conveyor type machine WW3 that includes, for example, a pre-wash zone Z1, a wash zone Z2, a rinse zone Z3 and a final-rinse zone Z4. The mobile unit 10 could be operated in a manual, automatic or semi-automatic mode. The mobile unit 10 may be in the form of a frame or other base structure 15 with wheels 14 to facilitate movement by a user from machine to machine. The unit includes additional on-board components and controls (as described below).

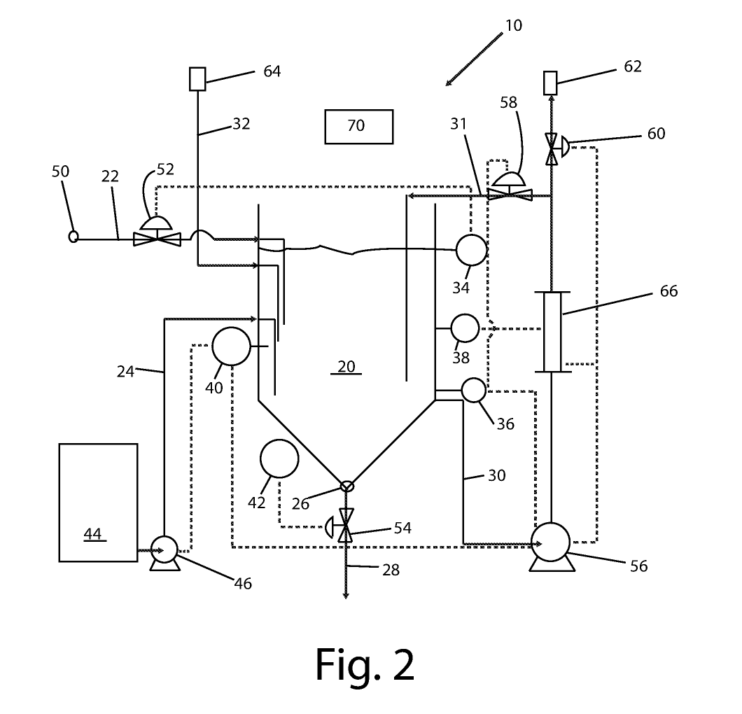

FIG. 2 is a schematic illustration of an automatic version of the unit 10, which includes a tank 20 having a fresh water input line 22, a delimer input line 24, a drain outlet 26 to a drain line 28, an internal recirculation path formed by delivery lines 30 and 31, and an external recirculation path formed by delivery line 30 and return line 32. The tank also includes an upper liquid level sensor 34, a lower liquid level sensor 36, a liquid temperature sensor 38, a delime solution strength sensor 40 (e.g., a total dissolve solids (TDS) meter, a conductivity meter or pH meter which could sense or measure differences in concentration or strength of a solution) and a solids sensor 42 (e.g., a turbidity meter or other sensor which can sense or measure differences in density or the presence of solids at the base of the tank). The fresh water input line 22 selectively delivers water from an input connection 50 to the tank 20 under control of a valve 52. The delimer input line 24 selectively delivers delimer concentrate from a container 44 to the tank 20 via operation of a pump 46. The drain line 28 selectively drains the tank 20 under control of a drain valve 54. The internal recirculation path 30, 31 selectively recirculates tank liquid under control of a pump 56 and a valve 58 to enable recirculation for the purpose of mixing the solution in the tank 20. The external recirculation path 30, 32 selectively recirculates solution from the tank 20, to a machine to be cleaned, and back to the tank 20 under control of the pump 56 and a valve 60. Output and input connectors 62 and 64 are provided for quick connection to a machine and may, for example, be at the free ends of flexible hosing. A heater 66, such as an in-line heating element, may be associated with line 31 for heating solution as it flows along the line. Alternatively, a heater could be located in the tank.

A controller 70 may be provided with connections to the sensors, valves and pumps to carry out cleaning operations for warewash machines. The controller 70 may be a separate processor and/or may be formed by integrated control logic or circuits of the sensors. In this regard, as used herein, the term controller is intended to broadly encompass any circuit (e.g., solid state, application specific integrated circuit (ASIC), an electronic circuit, a combinational logic circuit, a field programmable gate array (FPGA)), processor(s) (e.g., shared, dedicated, or group—including hardware or software that executes code), software, firmware and/or other components, or a combination of some or all of the above, that carries out the control functions of the unit 10 or the control functions of any component thereof.

By way of example, the unit 10 may be used for cleaning of a warewash machine as described below with a system preparation phase, followed by a cleaning phase followed by rinsing phase.

For system preparation, the unit 10 is first moved to the location of the warewash machine to be cleaned. The connectors 62 and 64 are connected to the required points on the warewash machine, connector 50 is connected to a fresh water input source, which may be a hot water source, and line 28 is connected to a suitable drain path. The unit is started (e.g., via an operator interface associated with the controller 70) and the controller 70 responsively opens the valve 52 to fill the tank 20 with fresh water while valves 54, 58 and 60 are closed. When the tank fills to the lower level indicated by the sensor 36, the controller turns on the delimer pump 46 to dose a predetermined amount of delimer from the delimer container 44. The controller then turns on the circulation pump 56 and opens valve 58 while valves 54 and 60 remain closed to mix the deliming solution while the tank continues to fill via the input line 22. The mixing operation may be continuous (pump 56 on continuously) or intermittent (pump 56 switching from on to off a number of times) until the tank fills to its highest level as indicated by sensor 34. While filling and mixing, sensor 40 measures and senses the deliming solution concentration in the tank and the controller 70 compares the detected concentration with a preset desired concentration (e.g. stored in memory). The delimer pump 46 is controlled to dose more chemical until the deliming solution in the tank is at or close to the desired concentration. A number of different preset concentrations may be provided in memory and selectable based upon, for example, designation of the type of warewash machine being cleaned.

Once the system is ready, with tank filled and proper solution concentration achieved, the cleaning process is carried out by closing, or maintaining closed, valves 52, 54 and 58 and opening valve 60 and turning on the circulation pump 56 to circulates the deliming solution from the tank 20 to the warewash machine and back. The controller 70 monitors the progress of the deliming process by evaluating the difference between the indication from the delime solution strength sensor 40 and a preset point, as explained more fully below.

For initial progress monitoring, the rate of solution change (RC) as defined by Equation (1) below, which is the difference between the concentration set point and the actual deliming solution concentration (e.g., TDS or conductivity) over a predetermined time t during the early external circulation process, is used to monitor the early progress of the deliming process.

$$Rate of Change ( RC ) = \frac{\begin{matrix}TDS \text{/} Conductivity Set Point - \\ Solution TDS \text{/} Conductivity at anytime\end{matrix}}{Predetermined Time diffrence from start of circulation} \qquad ( 1 )$$

An initial high RC value above a recommended value (e.g., above an acceptable predefined range) at the early stages of the deliming process suggests that more delimer is required because the delimer is being used up rapidly in the process. In this case the delimer pump 46 is turned ON and doses until the RC value is within the recommended rate at the early stage of the process.

The end point for the cleaning process is also determined as follows. After the early stages, the solution TDS/Conductivity will be sensed or measured by sensor 40 over a predetermined time where a current solution TDS/Conductivity, say S2, will be compared with a previous solution TDS/Conductivity, say S1, to define a new solution concentration rate of change (RCe) as in Equation (2).

$$Rate of Change ( RCe ) = \frac{\begin{matrix}Current Solution TDS \text{/} Conductivity ( S 2 ) - \\ Previous Solution TDS \text{/} Conductivity ( S 1 )\end{matrix}}{Predetermined Time diffrence between S 1 and S 2} \qquad ( 2 )$$

While the deliming process progresses, the deliming pump 46 will intermittently dose small predetermined amounts of delimer while sensor 40 measures or senses the solution concentration or strength in a predetermined time after dosing of the delimer for “n” number of times. Very low RCe values (e.g., below a set low threshold) for “n” number of measurements suggest the deliming process is close to completion (because the delimer concentration is not changing significantly) and the circulation pump 56 is then turned OFF after a predetermined time period.

In the course of the deliming process, sensor 42 monitors the base of the tank 20 to selectively drain out solids that settle and build up in the tank. The ON/OFF state of the in-line heating element 66 is controlled according to temperature sensed by sensor 38, where a threshold minimum desired temperature for the solution is set and element 66 controlled to maintain the minimum threshold.

The drain valve 54 is opened to drain the tank at a predetermined time after the pump 56 is stopped at the end of the cleaning process. A rinsing step can then be carried out. In particular, the tank 20 is drained until an acceptable reading from sensor 42 is achieved, and then the valve 52 is again opened to deliver fresh water while valve 54 remains open to allow flushing off some debris from the bottom of tank 20. The drain valve 54 is then closed a set time after valve 52 opens and the tank 20 fills. Valve 52 is closed when the fluid in the tank gets to the high level indicated by sensor 34, at which time valve 60 is opened and pump 56 is turned ON to activate the fresh water circulation to the warewash machine for a predefined rinse time period. After the predetermined time of rinse circulation, valve 58 is opened and valve 60 is closed, to also rinse of the recirculation line 31 of deliming solution for a set time period. The drain valve 54 is then opened to drain the spent deliming solution until the level in the tank reaches the lower level indicated by sensor 36, at which point the circulation pump 56 is turned OFF shut down for draining to occur under gravity. The drain valve 54 is closed a predetermined time after sensor 42 reads a predetermined value. The unit 10 can then be disconnected from the warewash machine and stored or moved to another warewash machine to carry out another cleaning process.

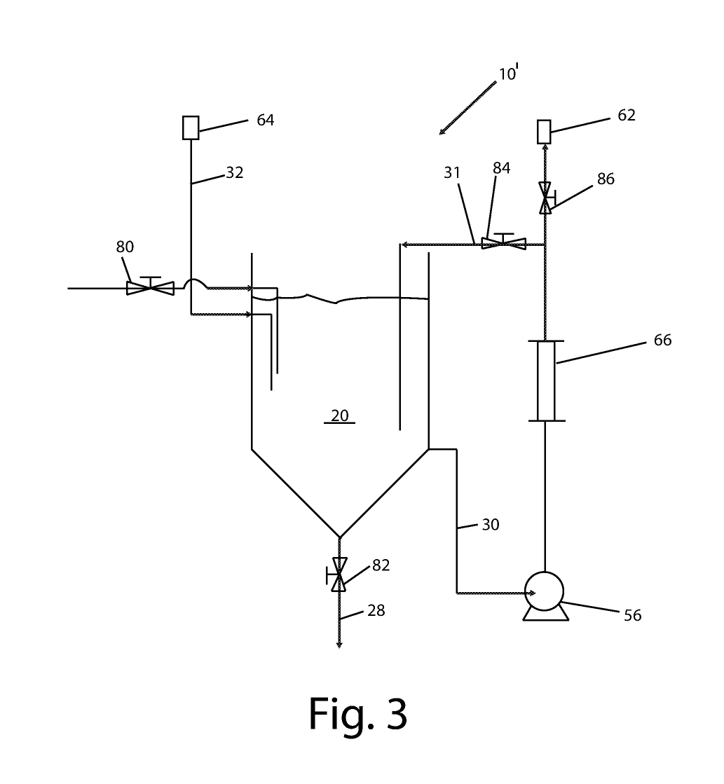

Referring to FIG. 3, a less automated, manual unit 10′ is shown and includes manual valves 80, 82, 84 and 86 associated with the tank 20. The cleaning process using the manual unit 10′ is basically the same as the automated process, except without the various automated control functions. Here the operator will manually need to pour the delimer into the tank 20 to make the deliming solution and manually test the solution until proper concentration is achieved. Moreover, the operator will manually have to open and close all the values during the operation including switching on and off the pump 56.

The use of mobile clean-in-place units or modules enable cleaning (primarily deliming) multiple warewash machines in a given establishment. The units may include a sensor or meter for detecting solids or change in density to initiate draining of the unit tank. The use of rate of change analysis in solution concentration in such units facilitates monitoring progress of the deliming operations.

It is to be clearly understood that the above description is intended by way of illustration and example only, is not intended to be taken by way of limitation, and that other changes and modifications are possible.

What is claimed is:

1. A mobile unit for cleaning warewashers at a facility, the unit comprising:
a base structure with wheels to facilitate movement;
a cleaning system mounted on the base structure and including:
a tank;
an external recirculation delivery line running from the tank and including a pump therealong;
an external recirculation return line running back to the tank;
wherein the delivery line and the return line are connectable to a warewash machine for recirculating liquid from the tank through the warewash machine and back to the tank for cleaning of the warewash machine.

2. The mobile unit of claim 1, further comprising a fresh water input line to the tank, and an internal recirculation line associated with the tank.

3. The mobile unit of claim 2 wherein the internal recirculation line partially overlaps with the external recirculation delivery line, a first valve controls flow along the fresh water input line to the tank, a second valve controls internal recirculation flow from the pump back to the tank, and a third valve controls external recirculation flow from the pump to an output of the delivery line.

4. The mobile unit of claim 3, further comprising a delime input line to the tank, and a delime pump or delime valve to control flow along the delime input line.

5. The mobile unit of claim 4, further comprising an upper tank liquid level sensor, a lower tank liquid level sensor, a liquid temperature sensor, at least one liquid quality sensor, and a controller responsive to the sensors and configured to control a cleaning operation carried out by the mobile unit.

6. The mobile unit of claim 5, wherein the controller is configured to carry out the following steps to prepare the mobile unit for a cleaning operation when the delivery line and return line are connected to a warewasher and a cycle is triggered:
opening the first valve to fill the tank with fresh water while the second and third valves remain closed;
when the liquid level of the tank reaches a lower level indicated by the lower tank liquid level sensor, turning on the delime pump or opening the delime valve to dose an amount of delimer into the tank;
while the first valve remains open to continue filling of the tank, turning on the pump and opening the second valve, while the third valve remains closed, to mix the delimer and fresh water in the tank;
continuing the mixing continuously or intermittently until the liquid level of the tank reaches a high level indicated by the upper tank liquid level sensor;
sensing a deliming solution concentration and comparing the sensed concentration with a preset desired concentration and responsively controlling the delime pump or delime valve to dose additional delimer until the deliming solution concentration in the tank reaches the preset desired concentration.

7. The mobile unit of claim 6 wherein the controller is further configured to carry out the following steps, as a cleaning cycle, after the preparation cycle:
closing the first and second valves, opening the third valve, and operating the recirculation pump so that deliming solution flows through the warewasher;
monitoring progress of the deliming process according to the at least one liquid quality sensor in order to (i) selectively dose additional delimer into the tank as needed and (ii) stop the cleaning cycle and (iii) carry out a rinsing cycle.

8. The mobile unit of claim 7 wherein progress of the deliming process is monitored by repeatedly determining a rate of change of deliming solution concentration.

9. The mobile unit of claim 8 wherein the controller is configured such that when the rate of change of the deliming solution concentration falls to a specified level, the flow of deliming solution through the warewasher is automatically stopped.

10. The mobile unit of claim 9 wherein the tank includes a drain outlet and associated fourth valve operating as a drain valve, wherein the controller is configured to subsequently drain the tank of deliming solution, refill the tank with fresh water and operate the recirculation pump with the third valve open so that rinse water flows through the warewasher to rinse the warewasher of deliming solution.

11. The mobile unit of claim 1 wherein the recirculation line includes an in-line heater.

12. A method of cleaning a warewasher in a facility, the method comprising:
(a) utilizing a mobile unit having an on-board cleaning system that includes a tank, an external recirculation delivery line running from the tank, an external recirculation return line running back to the tank, and an internal recirculation line from the tank and back to the tank;
(b) moving the mobile unit to a location of the warewasher;
(c) connecting the external recirculation delivery line to a liquid input of the warewasher and connecting the external recirculation return line to a liquid output of the warewasher;
(d) adding water and delimer to the tank;
(e) operating the mobile unit to move the water and delimer along the internal recirculation line in order to mix the water and delimer into a cleaning solution;
(f) operating the mobile unit to move the cleaning solution along the delivery line, through the warewasher and back along the return line for cleaning of the warewasher.

13. The method of claim 12 wherein the internal recirculation line partially overlaps with the external recirculation delivery line and a pump is located along a region of the overlap, a first valve controls internal recirculation flow from the pump back to the tank, and a second valve controls external recirculation flow from the pump to an output of the delivery line, in step (e) the pump is operated with the first valve open and the second valve closed, and in step (f) the pump is operated with the first valve closed and the second valve opened.

14. The method of claim 12 wherein:
during step (e) at least one sensor associated with the mobile unit is utilized to identify if the cleaning solution has a desired concentration and, if not, more delimer is automatically added under control of a delime pump or a delime valve to achieve the desired concentration.

15. The method of claim 12 wherein:
during step (f) at least one sensor associated with the mobile unit is monitored to track progress of cleaning of the warewash machine by repeatedly determining a rate of change of deliming solution concentration.

16. The method of claim 15 wherein when the rate of change of the deliming solution concentration falls to a specified level, step (f) is responsively stopped.

17. The method of claim 16 wherein step (f) is responsively stopped a specified time period after the rate of change of the deliming solution concentration falls to a specified level.

18. The method of claim 16 wherein after conclusion of step (f), the method includes automatically draining the tank of deliming solution, refill the tank with fresh water and operate the pump with the second valve open so that rinse water flows through the warewasher to rinse the warewasher of residual deliming solution.
